(19) United States
(12) Patent Application Publication
(10) Pub. No.: US 2002/0133421 A1
(43) Pub. Date: Sep. 19, 2002

(54) System and method for making a shopping list

(76) Inventor: Phillip R. Hutchens, Cassville, MO (US)

Correspondence Address: Susan J. Wharton, SHOOK, HARDY & BACON L.L.P., One Kansas City Place, 1200 Main Street, Kansas City, MO, 64105-2118, US

(21) Appl. No.: 09/811,793

(22) Filed: Mar. 19, 2001

(51) Int. Cl. G06F 17/60

(52) U.S. Cl. 705/26

(57) ABSTRACT

A computer system for making a shopping list and a method of using this system are provided. This system includes an input receiving component operable to be in communication with a scanner wherein it receives product identification data from the scanner, a processing component operable to be in communication with the input component for processing the data so as to form a shopping list, and a sorting component operable to be in communication with the processing component for sorting the data in the shopping list by one or more attributes of the product identification. A method of making a shopping list is also provided and includes obtaining scanned input identifying a product, processing the scanned input according to the inputted one or more identification attributes, and forming a shopping list. This method further includes sending a first data signal containing data of a shopping list to a store and receiving a second data signal from the store in response to the first signal.

### STATEMENT REGARDING FEDERALLY SPONSORED RESEARCH OR DEVELOPMENT

Not Applicable

### CROSS-REFERENCE TO RELATED APPLICATIONS

Not Applicable.

### BACKGROUND OF THE INVENTION

The present invention relates generally to a computer system and a method for using this system. More particularly, it relates to a computer system for making a shopping list.

Traditionally, when one goes shopping without a list, many times needed items are forgotten and return trips to the store must be made. Still further, while more items are usually remembered when a handwritten list is made, there are still many disadvantages to using handwritten lists. For instance, a pen or pencil is not always handy when an item needs to be written on a list, and thus, it becomes time consuming to list items. Still further, a handwritten list cannot be sorted or categorized without rewriting the list, another time consuming process. In addition, some people make computer lists for shopping. However, such lists are not easily made simultaneously as one thinks of a product that is needed. It is not handy to turn on a computer and type the name of a needed product onto a list every time a new product needs to be added.

Even when a handwritten or computer generated list is made, one must go to the store to obtain the items, call an order into the store, or go to a company's website and follow that company's instructions for ordering online. Still further, many times people go to the store only to find that the store is out of the product they desire to buy.

To overcome the deficiencies found with conventional methods of making shopping lists, a computer system for making a shopping list is needed. This system should be able to receive input from a scanner, make shopping lists based on the input, and sort the lists based on various criteria.

### SUMMARY OF THE INVENTION

The present invention is a method in a computer system of making a shopping list that includes providing a scanner, providing a processing unit in communication with the scanner, scanning a product with the scanner wherein a signal from the scanner containing data indicative of the product travels to the processing unit so as to be stored on a list, and sorting scanned data so as to form a shopping list categorized by a data attribute. This method further includes obtaining scanned input identifying a product, processing the scanned input according to the inputted one or more product identification attributes, and forming a shopping list from the product identification attributes. Still further, the present invention includes a computer-readable medium having computer-executable components able to perform the above-described method. This computer-readable medium having computer-executable components includes an input component operable to be in communication with a scanner wherein the input component receives data from the scanner, a processing component operable to be in communication with the input component for processing the data so as to form a shopping list, and a sorting component operable to be in communication with the processing component for sorting the data in the shopping list.

The present invention also includes a computer-readable medium having computer-readable instructions that includes a field having data indicative of a product identification for facilitating the making of a shopping list wherein this field includes data selected from the group consisting of product, product category, store, where the product was purchased, quantity, flavor or type, and brand name.

Still further, the system of the present invention includes a computer-readable medium having executable instructions that include a field having data indicative of a product identification for facilitating the making of a shopping list, data request means for receiving product identification information from a scanner, means coupled to the data request means for receiving processing data responsive to the scanned input, and means for making a shopping list with the processed data.

Still another embodiment of the present invention is a computer data signal embodied in a communication line that includes a first portion identifying scanned product identification information for one or more products, a second portion identifying a consumer request for one or more products, and a third portion identifying a store's information regarding a requested product.

A further embodiment of the present invention further includes a method of communicating between a scanner process and a consumer process, the method includes issuing, by the scanner process, a first set of data indicative of products desired; receiving, by the consumer process, sent data indicative of said desired products; processing, by the consumer process, said data; and producing, by the consumer process, a shopping list.

### BRIEF DESCRIPTION OF THE DRAWING

The objects and features noted above are explained in more detail with reference to the drawing figures, which form a part of this specification and are to be read in conjunction therewith, and in which like reference numerals are used to indicate like parts in the various views:

FIG. 1 is a block diagram showing the communication interface between consumers and stores in the system of the present invention;

FIG. 2 is a block diagram showing certain of the components of the consumer computer shown in FIG. 1;

FIG. 3 is a block diagram showing the input component shown in FIG. 2 in communication with a scanner and a keyboard;

FIG. 4 is a flow diagram of a method of making a shopping list in accordance with the present invention;

FIG. 5 is a block diagram of a data structure that may be communicated to the input component by the scanner;

FIG. 6 is a block diagram of a data structure of product identification data that may be received by the input component shown in FIG. 2;

FIG. 7 is a block diagram of a data structure of product and consumer information that may be transferred to a store from a consumer as shown in FIG. 1; and

FIG. 8 is a block diagram of a data structure for information received from a store.

### DETAILED DESCRIPTION OF THE PREFERRED EMBODIMENT

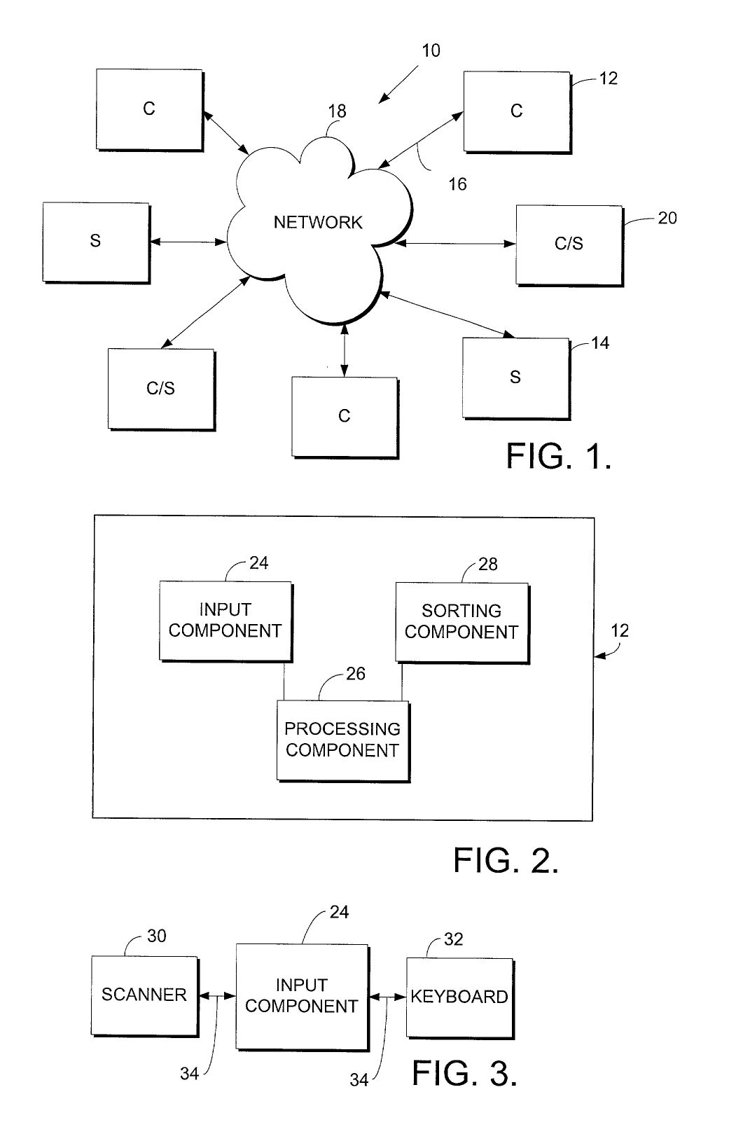

FIG. 1 illustrates an example of a suitable computing system environment in which the invention may be implemented. The computing system environment is only one example of a suitable computing environment and is not intended to suggest any limitation as to the scope of use or functionality of the invention. Neither should the computing environment be interpreted as having any dependency or requirement relating to any one or combination of components illustrated in the exemplary operating environment.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the invention is designated by reference numeral 10. This system includes a consumer (C) 12 and store (S) 14 connected by a network interface 16 to a network 18. Preferably, the network 18 is a global network, such as the Internet. As would be readily understood by one skilled in the art, the network 18 may include a local area network (LAN) or a wide area network (WAN) or any combination thereof. The variety of consumers and stores in communication with network 18 may also include a combination consumer and store (C/S) 20 for wholesale purposes. A consumer and store 20 can both buy and sell products. In some instances, it may buy products in bulk and then re-sell them at a higher price. Preferably, the consumer and/or store are implemented via any variety of computer environments, such as those described above.

Consumer component 12 is shown in more detail in FIG. 2. The consumer component 12 includes an input component 24, a processing component 26, and a sorting component 28. Consumer computer 12 is in communication with a scanner 30 and a keyboard 32 via interface 34, as shown in FIG. 3.

Input component 24 receives product and consumer information from scanner 30 and keyboard 32. Examples of such information that may be received are shown in FIG. 5 as fields 36. These fields 36 include, but are not limited to, UPC code 38, product text 40, quantity 42, and brand name 44. Scanner 30 may be any device that can read input from a label on a product and from that input identify certain attributes of the product. One example of a scanner 30 is a bar code scanner.

Processing component 26 receives the input data and processes the data so as to form a shopping list. Sorting component 28 may sort the data listed in the shopping list by a number of different fields 46, as shown in FIG. 6. These fields 46 may include, but are not limited to, product 48, product category 50, the store in which the product was purchased 52, quantity 54, flavor or type 56, and brand name 58.

Preferably, consumer component 12, store component 14 and consumer/store component 20 are implemented in one or more computing environments, such as a server, in communication with the network 18 via the network interface 16, which are in communication over any variety of network communication lines such as, but not limited to, telephone lines, cables and satellites. Consumers 12, stores 14, and consumer/stores 20 may have, for example, a remote or local connection and a dial-up or satellite connection. Consumers, stores, and consumers/stores may, but not necessarily will, communicate through personal computers, hand-held or laptop devices, or network PCs. Preferably, a scanner is placed near a trash can in the kitchen so that items can be scanned as they are thrown away.

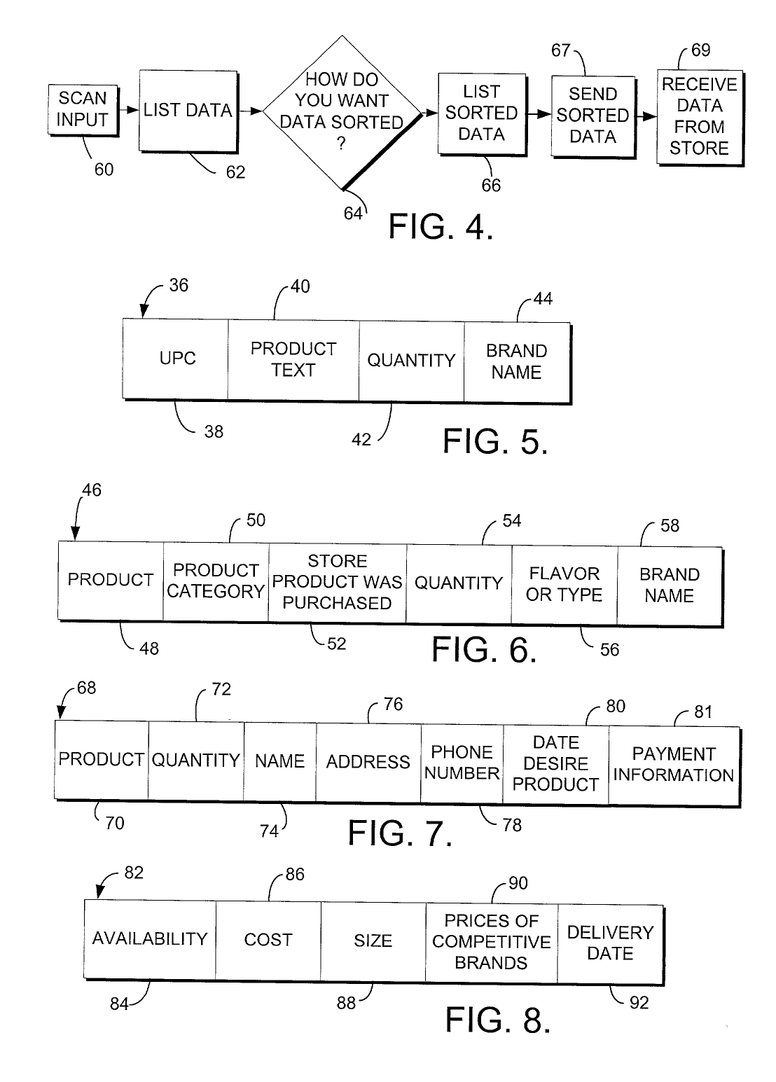

The method of the present invention may take place as illustrated in the flow diagram of FIG. 4. The method includes scanning input 60, listing data 62, determining how one wants the data sorted 64, and listing the sorted data 66. The method may, but need not, further include sending sorted data to a store 67, and receiving data from the store 69. Information may be sent to a store from a consumer to order and/or inquire about products. The data received from the store may include pricing information or confirmation information regarding an order. Additional information about a scanned product or information about a product that cannot be scanned may be manually input via keyboard 32.

Examples of information that can be transferred to a store via the network 18 are shown in FIG. 7 as fields 68. Fields 68 include, but are not limited to, product 70, quantity 72, consumer's name 74, consumer's address 76, consumer's telephone number 78, the date on which products are desired 80, and payment information 81. Payment information 81 may include credit card or bank card information.

The store may respond to the information received (see numeral 69 of FIG. 4) by transferring data to the consumer via the network 18 as shown in FIG. 8 as fields 82. Fields 82 include, but are not limited to, availability 84, cost 86, size 88, prices of competitive brands 90, and delivery date 92.

In use, a product is scanned by scanner 30, and the scanned data, which may be from one of the fields listed in FIG. 5, is communicated to the input component 24 of consumer component 12. The processing component 26 processes the scanned data through an algorithm so as to produce a linear listing of products in the order in which they are scanned. This listing of products is a shopping list. UPC code that is scanned may also contain additional information about a product that may be listed on the shopping list. This list may be sorted by a sorting component 28 by any of a number of different attributes of the product obtained from the scanned input. For instance, it may be sorted alphabetically or by product type. For groceries, they may be sorted in to canned foods, dairy, breads, vegetables, fruits and meat. In one embodiment of the present invention, consumer component 12 is in a personal digital assistant (PDA) hand-held device and scanner 30 is linked to the hand-held device.

The shopping list may also be printed from the computerized list, and the consumer may take the list with him or her to the store. Still further, the list need not be printed if it is listed on a hand-held device but merely can be taken to the store on the device.

This shopping list may be transferred to one or more stores 14 by processing component 26 so as to request the various products on the list. Either the sorted or unsorted list may be sent to a store. The consumer 12 may order products when sending the list or may merely inquire as to price, brands, availability, etc. before buying. If doing the latter, in response to an initial request, the store may send information regarding availability, cost, size, prices of other brands, prices of similar products, or delivery dates. The consumer 12 may automatically compare prices or other attributes and then send an order request for certain products, such as the cheapest products or products that can be obtained by a certain date. Alternatively, the consumer component 12 may wait for a manual queue from the consumer to actually order products. Products may be ordered by specifying a number of characteristics about the products. Furthermore, a store may send information to a consumer stating the delivery or pickup date for the products.

It is specifically contemplated that this invention is useful for making shopping lists and buying products online. The method and system of the present invention allows consumers to make more accurate shopping lists and to compare product prices from more suppliers faster and easier than previous systems and methods available. The method and system of the present invention also allows more organized shopping lists to be made so that desired items can be categorized by store or areas within a particular store for easier shopping. Store computers that may be part of the system include grocery stores, department stores, and discount stores. Preferably, the scanner of the present invention is placed near a trash can in the kitchen so that items can be scanned as they are thrown away.

A method of making a shopping list in a computer system is provided. This includes providing a scanner, providing a processing unit in communication with the scanner, scanning a product with the scanner wherein a signal from the scanner containing data indicative of the product is communicated to the processing unit so as to be stored on a list, and sorting scanned data so as to form a shopping list categorized by a data attribute. Another aspect of this method may include obtaining scanned input identifying a product, processing the scanned input according to the inputted one or more product identification attributes, and forming a shopping list from the product identification attributes.

Still further, a computer-readable medium having computer-executable components able to perform the above-described method is provided. This computer-readable medium having computer-executable components includes an input component operable to be in communication with a scanner wherein the input component receives data from the scanner, a processing component operable to be in communication with the input component for processing the data so as to form a shopping list, and a sorting component operable to be in communication with the processing component for sorting the data in the shopping list. The input component may also receive input from a keyboard in addition to receiving input from the scanner.

A computer-readable medium having computer-readable instructions is also provided as another embodiment of the present invention. This medium includes a field having data indicative of a product identification for facilitating the making of a shopping list wherein this field includes data selected from the group consisting of product, product category, store, where product was purchased, quantity, flavor or type, and brand name. This system may also include other fields, such as for specifying consumer identification information for facilitating the ordering of products and for receiving information regarding orders from stores.

Another embodiment of the present invention includes a computer-readable medium having identification-executable instructions for forming a field having data indicative of a product identification for facilitating the making of a shopping list, data request means for receiving product identification information from a scanner, means coupled to the data request means for receiving and processing data responsive to the scanned input, and means for making a shopping list with the processed data.

Still another embodiment of the present invention is a computer data signal embodied in a communication line that includes one or more of the following portions: a first portion identifying scanned product identification information for one or more products for creating a shopping list, a second portion identifying a consumer request for one or more products for sending a shopping list to a store, and a third portion identifying a store's information regarding a requested product from a shopping list.

Still further, a method of communicating between a scanner process and a consumer process is provided. The method includes issuing, by the scanner process, a first set of data indicative of products desired; receiving, by the consumer process, sent data indicative of desired products; processing, by the consumer process, data; and producing, by the consumer process, a shopping list. This method may also include sorting, by the consumer process, the shopping list according to the data indicative of the products. This method may further include communicating between a consumer process and a store process by issuing, by the consumer process, a shopping list of products desired; receiving, by the store process, the shopping list; processing, by the store process, the shopping list; and producing, by the store process, data regarding the requested products.

Alternative embodiments of the present invention will become apparent to those skilled in the art to which it pertains upon review of the specification, including the drawing figures. It will be appreciated that none of the various features or embodiments of the present invention are considered to be critical or essential elements of the invention unless they have been expressly labeled as “critical” or “essential”. Accordingly, the scope of the present invention is defined by the appended claims rather than the foregoing description.

I claim:

1. A computer-readable medium having computer-executable components adaptable to be in communication with a scanner for creating a shopping list, comprising:
an input component operable to be in communication with said scanner, wherein said input component receives data from said scanner; and
a processing component operable to be in communication with said input component for processing said data so as to form a shopping list.

2. The computer-readable medium of claim 1, further comprising:
a sorting component operable to be in communication with said processing component for sorting said data in said shopping list.

3. The computer-readable medium of claim 2, wherein said input component is further able to receive input from a keyboard.

4. The computer-readable medium of claim 2, wherein said data can be sorted by UPC code, product text, quantity, brand name, product, product category, store product was purchased, flavor, or type.

5. A computer-readable medium having computer-readable instructions for creating a shopping list, comprising:
a field having data indicative of a product identification for facilitating the making of a shopping list, wherein said field having data indicative of a product identification includes data selected from the group consisting of product, product category, store product was purchased, quantity, flavor or type, and brand name.

6. The computer-readable medium of claim 5, further comprising:
a field for specifying consumer identification information for facilitating the ordering of one or more products identified in the product identification field from a store, wherein said field having data indicative of consumer identification information includes product, quantity, consumer's name, consumer's address, consumer's telephone number, and the date consumer desires the product.

7. A computer data signal embodied in a communication line, comprising:
a first portion identifying scanned product identification information for one or more products for creating a shopping list.

8. The computer data signal of claim 8, further comprising:
a second portion identifying a consumer request for one or more products.

9. The computer data signal of claim 8, further comprising:
a third portion identifying a store's information regarding a requested product.

10. A method in a computer system for making a shopping list, comprising:
obtaining scanned input identifying a product, wherein said scanned input includes one or more product identification attributes;
processing said scanned input according to said inputted one or more product identification attributes; and
forming a shopping list from said product identification attributes.

11. A computer-readable medium having computer-executable instructions operable to perform the steps recited in claim 10.

12. A method of communicating between a scanner process and a consumer process, the method comprising:
issuing, by the scanner process, a first set of data indicative of products desired;
receiving, by the consumer process, said data indicative of said desired products;
processing, by the consumer process, said data; and
producing, by the consumer process, a shopping list.

13. The method of claim 12, further comprising:
sorting, by the consumer process, said shopping list according to said data indicative of said products.

14. The method of claim 12, further comprising communicating between a consumer process and a store process, the method comprising:
issuing, by the consumer process, said shopping list of products desired;
receiving, by the store process, said shopping list of said desired products;
processing, by the store process, said shopping list; and
producing, by the store process, data regarding the requested products.

15. A computer-readable medium having identification-executable instructions, comprising:
a field having data indicative of a product identification for facilitating the making of a shopping list;
data requests means for receiving product identification information from a scanner;
means coupled to said data request means for receiving and processing data responsive to said scanned input; and
means for making a shopping list with said processed data.

16. A method in a computer system of making a shopping list of one or more products, comprising:
providing a scanner;
providing a processing unit in communication with said scanner;
scanning the product with said scanner, wherein a signal from said scanner containing data indicative of said product is communicated to said processing unit so as to be stored on a list; and
sorting said scanned data by an attribute so as to form a shopping list categorized by an attribute.

17. The method of claim 16, further comprising:
sending a first signal containing data of said shopping list to a store;
receiving a second signal from said store in response to said first signal.

18. A computer-readable medium having computer-executable instructions operable to perform the steps recited in claim 16.

19. A computer-readable medium having computer-executable instructions operable to perform the steps recited in claim 17.
